(19) United States
(12) Patent Application Publication
(10) Pub. No.: US 2010/0045156 A1
(43) Pub. Date: Feb. 25, 2010

(54) Electrode for a spark plug

(76) Inventors: Lars Menken, Donzdorf (DE); Klaus Czerwinski, Leonberg (DE); Thomas Kaiser, Alcala De Henares (Madrid) (ES); Alexander Flaig, Stuttgart (DE); Jochen Boehm, Marbach (DE); Jochen Rager, Bisingen (DE)

Correspondence Address: KENYON & KENYON LLP, ONE BROADWAY, NEW YORK, NY, 10004, US

(21) Appl. No.: 11/918,999

(22) PCT Filed: Mar. 20, 2006
(86) PCT No.: PCT/EP2006/060884

§ 371 Date: Nov. 6, 2009

(30) Foreign Application Priority Data
Apr. 21, 2005 (DE) 0 2005 018 674.2

(51) Int. Cl. H01T 13/39

(52) U.S. Cl. 313/141

(57) ABSTRACT

An electrode is provided for a spark plug made of a base material and at least one additive material situated in the base material in a dispersedly distributed manner, which is intercalated in the base material, and is a metal oxide, and is characterized by a negative enthalpy of formation greater than 800 kJ/mol O₂. The base material is an Au based or an Rh based material or is pure Au or Rh, the proportion of the additive material amounting to between 5 vol. % and 50 vol. %. Alternatively, Pt-based materials or pure Pt are provided as the base material, the proportion of the additive material at average particle diameters of the additive material between 5 μm and 20 μm amounting to between 21 vol. % and 50 vol. % or the additive material being at least one metal oxide from the group of the rare earth metal oxides and/or at least one metal oxide from the group Al₂O₃, Y₂O₃, Sc₂O₃, CaO, SrO, BaO and/or at least one mixed oxide, such as spinel, made up of at least one alkaline earth metal oxide, one rare earth metal oxide, Al₂O₃, Y₂O₃ and/or Sc₂O₃, the proportion of the additive material amounting to between 5 vol. % and 50 vol. %.

### BACKGROUND INFORMATION

The present invention relates to an electrode for a spark plug that is formed from a base material and at least one additional material intercalated in the base material that is distributed in a dispersed manner in the base material.

Internal combustion engines known in practice, that have externally supplied ignition, convert the energy contained in the fuel to kinetic energy, a fuel mixture injected into a combustion chamber being inflamed via externally supplied ignition that is controlled with respect to time. The ignition of an Otto engine is performed electrically, an ignition system controlled by the engine periodically generating a high voltage. This high voltage causes a sparkover in each case between the electrodes of the spark plugs in the combustion chamber. The energy contained in the spark inflames the compressed air/fuel mixture, the spark plug having to apply the ignition energy in the combustion chamber under all operating conditions, without becoming leaky or hot.

During operation, the electrodes of a spark plug are exposed to high stresses by the ignition spark, as well as thermochemical attack, which bring about erosion as well as corrosion at the electrodes. In order to counter the electrode wear that occurs because of spark erosion and corrosion in the combustion chamber during operation, spark plug electrodes are made of materials whose characteristics are that they have a low tendency to oxidize and corrode, as well as having a high resistance to wear caused by spark erosion attack. Materials made of pure noble metals or based on noble metals, such as platinum-based alloys or platinum-iridium-based alloys demonstrate the best properties in this connection. Additional suitable electrode materials are nickel and silver, as well as nickel-based alloys and silver-based alloys.

The arc created by the ignition of the spark causes spark-erosive wear at the electrode, and up to now, besides the pure oxidation attack, the fundamental wear mechanism was regarded as the spraying off of molten metal droplets from the electrode.

An electrode is known from DE 196 31 985 A1, having a wear-resistant coating that is applied on a base body of the electrode using a thermal coating method. It is provided to supply the coating material in the form of powder to an energy rich heat source and to burn it on. The molten particles of the coating material are accelerated in the direction of a substrate, i.e. the base body of the electrode, and they impinge, mostly at high speed, in order to form a layer. Layers sprayed on thermally in that manner are distinguished by layer thicknesses in the range of 100 μm up to a few millimeters, the binding mechanism being based either on mechanical clinging, adhesion, diffusion, chemical binding or electrostatic forces.

However, the disadvantage is that the production of the wearing layer, to be applied for increased¹ wear, requires costly equipment and if the wearing layer is damaged, the base body of the electrodes is submitted, during operation, to the highly corrosive as well as spark-erosive stresses unprotected. ¹ Translator's Note: It seems that the words “resistance to” were left out here.

A spark plug for an internal combustion engine is known from DE 100 15 642 A1, whose electrode is designed to have a region that is highly resistant to arc erosion, which forms a part of the end face of the electrode facing the spark gap. The region that is highly resistant to arc erosion is made up of an alloy which has at least the alloy components iridium and nickel, and is welded to the base electrode.

However, this known spark plug for an internal combustion engine has the disadvantage that its electrode does not have a homogeneous material structure between the base electrode and the region that is highly resistant to spark erosion, that is welded onto it, whereby the thermal conductivity of the electrode is impaired, which, in certain operating areas leads to undesirably high thermal stresses of the electrode, and thus to a reduction in the service life of the spark plug.

A spark electrode is known from DE 30 38 649 C2 which is produced from a mixture of a metallic compound and an electrically conductive substance containing a noble metal.

As metallic compound it provides a titanium compound, such as TiO₂, TiC and/or TiN, or a mixture of TiO₂ and TiC, or of TiN and TiC, whereas, as the noble metal, it provides Pt, a mixture of Pt and Pd, a mixture of Pt and at least one of the elements Au, Ru, Ag and Rh or a mixture of Pt, Pd and at least one of the elements Au, Ru, Ag and Rh. Furthermore, additional substances may be added to the above mixtures of the metallic compound and the noble metal proportion as base metal, as oxide, as carbide, as nitride and/or as silicide.

The proportions of the individual substances of the mixture are, among others, at least 10 to 30 wt. % titanium compound powder, 40 to 60 wt. % platinum powder and 20 to 30 wt. % palladium powder, it being possible to add to each mixture, of a titanium compound and a noble metal, up to 3 wt. % base metal and altogether up to 10 wt. % oxide, carbide, nitride and silicide.

The spark electrode known from DE 30 38 649 C2, which is made of a mixture of an additive material, i.e. a titanium compound, and of a base material that is at least Pt or a Pt—Pd mixture, has the disadvantage that the titanium compounds break up during a sintering process to a not insubstantial degree, and the liberated titanium forms new compounds with the platinum of the base material.

These Ti—Pt compounds, newly developing during a sintering process, are disadvantageously very brittle, which is why the spark electrode is able to processed further only with great difficulty after the sintering process. In addition, the aim striven for, by adding titanium compounds to platinum or to Pt base materials, to increase the melting point of a spark electrode based on platinum or a Pt-based material, and thereby to improve the resistance to erosion of the spark electrode, is not achieved in the full measure desired. This does not lead to an increase in service life of a spark plug.

Therefore, the present invention is based on the object of providing an electrode for a spark plug which is easy and cost-effective to manufacture and which has a long service life.

This object is attained, according to the present invention, by an electrode for a spark plug having the features of Claims 1, 8 and 15.

### ADVANTAGES OF THE INVENTION

Compared to the spark plug electrodes known from the related art, an electrode for a spark plug developed according to the present invention, having the features of Claims 1, 8 and 15, has the advantage that low electrode wear is achieved along with low manufacturing costs.

This is achieved in that, in a base material of the electrode, which is an Au or Rh base material or pure Au or Rh, at least one additive material is provided, that is arranged to be dispersedly distributed and developed as a metal oxide, and that is intercalated in the base material, and is characterized by a negative enthalpy of formation greater than 800 kJ/mol O₂, the proportion of the additive material amounting to between 5 vol. % and 50 vol. %.

The above advantages are also achieved in that, in a base material of the electrode, which is a Pt-based material or pure Pt, at least one additive material is provided, that is arranged to be dispersedly distributed and developed as a metal oxide, and that is intercalated in the base material, and is characterized by a negative enthalpy of formation greater than 800 kJ/mol O₂, the proportion of the additive material amounting to between 21 vol. % and 50 vol. %, and an average diameter (D50) of the additive material is between 5 μm and 20 μm.

Alternatively, there is also the possibility of adding, to a Pt-based material or pure Pt, a metal oxide from the group of the rare earth metal oxides [rare earth oxides] and/or at least one metal oxide from the group Al₂O₃, Y₂O₃, Sc₂O₃, CaO, SrO, BaO and/or at least one mixed oxide such as a spinel, of at least one alkaline earth metal oxide [alkaline earth oxide], one rare earth metal oxide, Al₂O₃, Y₂O₃ and/or Sc₂O₃ as additive material, the additive material having a negative enthalpy of formation greater than 800 kJ/mol O₂, and the proportion of the additive material (12) amounting to between 5 vol. % and 50 vol. %.

Using the material compositions of an electrode of a spark plug, according to the present invention, in an advantageous manner the possibility exists of reducing the cost-intensive noble metal proportion of an electrode, without reducing the resistance to spark erosion of an electrode, whereby, in a simple manner, the manufacturing costs of a spark plug will be reduced, compared to the usual spark plugs, at a service life that remains at least the same.

By the addition of additive materials developed as metal oxides having a negative enthalpy of formation greater than 800 kJ/mol O₂, one takes into account the knowledge that resistance to spark erosion of electrodes, whose base materials are formed of noble metals, deteriorates during the operation of an internal combustion engine because of oxidation of the base material which takes place both based on the oxygen present in the environment and based on the oxygen liberated, during the operation of the spark plug, by the splitting up of the metal oxides present in the electrode, and that is why the service life of a spark plug is disadvantageously reduced.

Thus, because of oxidation in a platinum-based material electrode, for instance, or in an electrode whose base material is made of pure platinum, a volatile gaseous platinum oxide is formed which is disadvantageously removed from the electrode during operation of the spark plug. Since metal oxides are already at the highest stage of oxidation, they are protected from further oxidation. In order to avoid that the oxygen of the metal oxide is given off to the base material because of the action of the spark, and that the above-named oxidation processes take place, the base material has added to it metal oxides having such negative enthalpies of formation that, under the operating conditions of the spark plug, they have a sufficiently stable binding so that the oxygen of the metal oxides is not split off, and is therefore not available for oxidation of the base material.

It was established in experiments, in this context, that the resistance to spark erosion of a spark plug electrode containing a high proportion of a noble metal became greater by the addition of a metal oxide, such as MgO, whose negative enthalpy of formation is about 1200 kJ/mol O₂, compared to an electrode that is developed without metal oxide or with metal oxide whose negative enthalpy of formation is in the range below 800 kJ/mol O₂. This means that higher stabilities of the compounds of the metal oxides provided as additive materials lead to an improvement of the spark erosion resistance of an electrode with increasing negative enthalpy of formation.

Advantageous embodiments of the present invention form the additional subject matter of the dependent claims.

In one advantageous refinement, the proportion of the additive material on an electrode having the features of Claim 1 preferably amounts to between 10 vol. % and 30 vol. %, and in an electrode having the features of Claim 8 it amounts to between 21 vol. % and 30 vol. %.

In another advantageous embodiment of an electrode according to Claim 1, an average particle diameter (D50) of the additive material lies between 0.5 μm and 20 μm, preferably between 1 μm and 7 μm, so that an electrode is able to be produced cost-effectively, since larger particle sizes result in processing times that are considerable and increase manufacturing costs because of long extended glow processes.

Further advantages and advantageous refinements of the subject matter in accordance with the present invention result from the description, the drawing and the patent claims.

### BRIEF DESCRIPTION OF THE DRAWING

An exemplary embodiment of the subject matter according to the present invention is shown in a simplified schematic version in the drawing and is elucidated in more detail in the following description. The figures show:

FIG. 1 a schematic representation of a spark plug in a partial sectional view; and

FIG. 2 a ground electrode of the spark plug shown in FIG. 1, in a cross section in isolation.

### DESCRIPTION OF THE EXEMPLARY EMBODIMENT

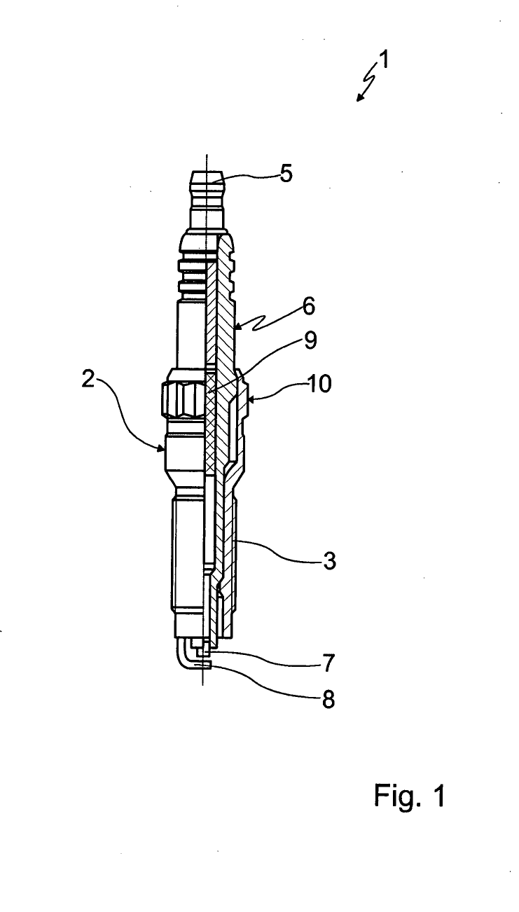

With reference to FIG. 1, a partial sectional view is shown of a spark plug 1 that is able to be positioned in the cylinder head of an internal combustion engine, and is able to be screwed into an inner thread of the cylinder head using its outer thread 3 that is developed on a housing 2.

Spark plug 1 that is developed in a way known per se is made up in the present case of metal, ceramic and glass. These materials have different properties that are utilized by the construction of spark plug 1 in a manner appropriate for the material. The most important components of spark plug 1 are a terminal stud 5, an insulator 6, the housing 2, a center electrode 7 and a ground electrode 8, a glass melt 9, that is situated in insulator 6 and is electrically conductive, connecting center electrode 7 to terminal stud 5.

Center electrode 7 and ground electrode 8 are exposed to great wear during the operation of the internal combustion engine, which is caused by erosion and corrosion. The two factors cannot be treated separately in their effect on wear. The wear brings about an increase in the ignition voltage. Furthermore, good thermal conductivity is required of the electrodes.

Depending on operating conditions and the particular application, the requirements are able to necessitate different electrode shapes and electrode materials.

Basically, pure metals conduct heat better than metal alloys do. On the other hand, pure metals, such as nickel, react to chemical attack by combustion gases and solid combustion residues more susceptibly than alloys.

For this reason, electrodes of spark plugs known from practical applications are made of nickel, for example, which has been alloyed with chromium, manganese and silicon, among others. The metals added to the alloy have special tasks to fulfill. Thus, for example, manganese and silicon additives increase the chemical stability, above all to very aggressive sulfur dioxide. Nickel-based alloys having additives made of silicon, aluminum and yttrium additionally improve resistance to scaling and oxidation.

Besides these, silver is also used as an electrode material. This comes from the fact that silver, of all materials, has the highest electrical and thermal conductivity, and that it is also extraordinarily stable chemically, as long as lead-free fuel is used. A considerable increase in heat resistance is attained by particle composite materials based on silver. The properties of silver that were mentioned are important for its use as electrode material.

In addition, platinum and platinum-based alloys are also used for the production of electrodes, since these have very good resistance to corrosion and oxidation, as well as a high resistance to erosion.

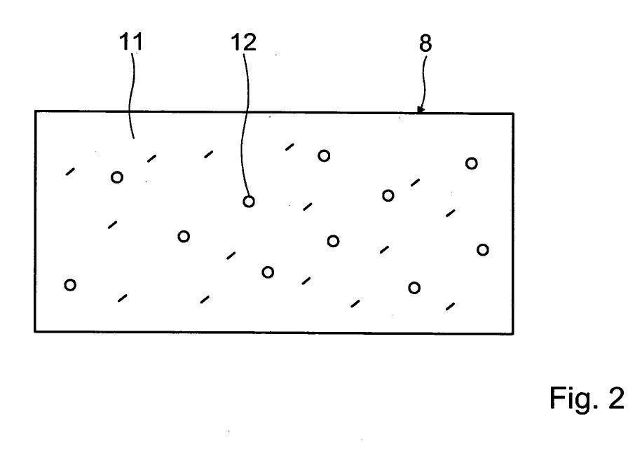

FIG. 2 shows ground electrode 8 in a cross sectional view in isolation, and it has an essentially rectangular cross section, with the aid of which the present invention will be described below in exemplary fashion, since center electrodes of spark plugs are also able to be designed according to the present invention. Ground electrode 8 is made up of a base material 11 and at least one additive material 12 situated in the base material 11 in the most finely distributed manner, which is intercalated in the base material 11, and which, based on its distribution, its material properties and its interaction with base material 11 does not impair the resistance to wear of ground electrode 8, and even improves it under certain circumstances in response to the appropriate selection of its material.

Base material 11 of ground electrode 8 may be Au-based or Rh-based material, or pure Au or Rh. As additive material, at least one metal oxide is provided having a negative enthalpy of formation greater than 800 kJ/mol O₂, such as particularly alkaline earth metal oxides, rare earth metal oxides, Al₂O₃, Y₂O₃, Sc₂O₃, ZrO₂ and their mixed oxides, such as spinels or MgO having particle sizes, or rather average diameters D50 of between 0.5 μm to 20 μm, preferably between 1 μm and 7 μm, and proportions of 5 vol. % to 50 vol. %, preferably 10 vol. % to 30 vol. %.

Alternatively to this, base material 11 of ground electrode 8 may be a Pt base material or pure Pt, to which is added as additive material at least one metal oxide having a negative enthalpy of formation greater than 800 kJ/mol O₂. Provided as additive material are particularly alkaline earth metal oxides, rare earth metal oxides, Al₂O₃, Y₂O₃, Sc₂O₃, ZrO₂ and their mixed oxides, such as spinels or MgO having particle sizes, or rather average diameters D50 of between 5 μm to 20 μm, preferably between 5 μm and 7 μm, and proportions of 21 vol. % to 50 vol. %, preferably 21 vol. % to 30 vol. %.

In an additional alternative design approach, it is provided that the base material of ground electrode 8 is a Pt-based material or pure Pt, and that the additive material is at least one metal oxide from the group of the rare earth metal oxides and/or at least one metal oxide from the group Al₂O₃, Y₂O₃, Sc₂O₃, CaO, SrO, BaO and/or at least one mixed oxide such as a spinel, of at least one alkaline earth metal oxide, one rare earth metal oxide, Al₂O₃, Y₂O₃ and/or Sc₂O₃, the additive material having a negative enthalpy of formation greater than 800 kJ/mol O₂, and the proportion of the additive material 12 amounting to between 5 vol. % and 50 vol. %.

In all the alternatives named above, additive material 12 is situated in base material 11 in the form of small particles and in fine dispersion. The perfusion among the particles of additive material 12 and base material 11, the volume content of the additive material as well as the grain size of the particles of the additive material have the effect that the service life of the electrodes is the same or improved, at substantially lower material costs, in comparison to electrodes for spark plugs or electrodes formed from the previously named base materials that are known from practice, since oxidation of the base material is not favored by the presence of the more cost-effective metal oxide, or rather is even improved by the appropriate material selection of the additive material.

The improvement of the stability of the electrode with respect to oxidation is attained by the high negative enthalpy of formation of the additive material, since the energy input of the arc of the spark plug's ignition spark into the electrode is not sufficient to break the atomic bond of the metal oxide. That being the case, on the part of the additive material, only a little oxygen or none at all is made available for the oxidation of the base material.

For this reason, the electrodes designed according to the present invention have the same or an improved spark erosion resistance compared to electrodes known from the related art. This applies both to Au alloys and Rh alloys and also to Pt alloys. In the case of pure Pt, Au and Rh electrodes, adding the additive material achieves a reduction in production costs at a resistance to wear that remains at least approximately the same.

Using electrodes developed according to the present invention, at the same performance, and at the same or longer service life, the costs of noble metals may be lowered and by using a larger material volume, a longer service life of spark plugs is able to be realized.

1-17. (canceled)

18. An electrode for a spark plug, comprising:
a base material; and
at least one additive material arranged in the base material in a dispersedly distributed manner, which is intercalated in the base material;
wherein the base material is at least one of (a) an Au-based material, (b) an Rh-based material, (c) pure Au and (d) pure Rh, and the additive material is at least one metal oxide having a negative enthalpy of formation greater than 800 kJ/mol O₂, a proportion of the additive material amounting to between 5 vol. % and 50 vol. %.

19. The electrode according to claim 18, wherein the proportion of the additive material amounts to between 10 vol. % and 30 vol. %.

20. The electrode according to claim 18, wherein an average particle diameter of the additive material is one of (a) between 0.5 μm and 20 μm and (b) between 1 μm and 7 μm.

21. The electrode according to claim 18, wherein the additive substance is one of (a) an alkaline earth metal oxide and (b) a rare earth metal oxide.

22. The electrode according to claim 18, wherein the additive substance is one of (a) Al₂O₃, (b) Y₂O₃, (c) ZrO₂ and (d) Sc₂O₃.

23. The electrode according to claim 18, wherein MgO is intercalated in the base material.

24. The electrode according to claim 18, wherein mixed oxides including at least one of (a) an alkaline earth metal oxide, (b) a rare earth metal oxide, (c) Al₂O₃, (d) Y₂O₃, (e) Sc₂O₃, (f) ZrO₂ and (g) MgO are intercalated in the base material.

25. The electrode according to claim 24, wherein the mixed oxides include spinels.

26. An electrode for a spark plug, comprising:
a base material; and
at least one additive material situated in the base material in a dispersedly distributed manner, which is intercalated in the base material;
wherein the base material is one of (a) a Pt-based material and (b) pure Pt and the additive material is at least one metal oxide having a negative enthalpy of formation greater than 800 kJ/mol O₂, a proportion of the additive material amounting to between 21 vol. % and 50 vol. %.

27. The electrode according to claim 26, wherein the proportion of the additive material is between 21 vol. % and 30 vol. %.

28. The electrode according to claim 26, wherein an average particle diameter is one of (a) between 5 μm and 20 μm and (b) between 5 μm and 7 μm

29. The electrode according to claim 26, wherein the additive material is one of (a) an alkaline earth metal oxide and (b) a rare earth metal oxide.

30. The electrode according to claim 26, wherein the additive substance is one of (a) Al₂O₃, (b) Y₂O₃, (c) ZrO₂ and (d) Sc₂O₃.

31. The electrode according to claim 26, wherein MgO is intercalated in the base material.

32. The electrode according to claim 26, wherein mixed oxides including at least one of (a) an alkaline earth metal oxide, (b) a rare earth metal oxide, (c) Al₂O₃, (d) Y₂O₃, (e) Sc₂O₃, (f) ZrO₂ and (g) MgO are intercalated in the base material.

33. The electrode according to claim 32, wherein the mixed oxides include spinels.

34. An electrode for a spark plug, comprising:
a base material; and
at least one additive material situated in the base material in a dispersedly distributed manner, which is intercalated in the base material;
wherein the base material is one of (a) a Pt-based material and (b) pure Pt, and the additive material is at least one of (a) at least one metal oxide from the group of the rare earth metal oxides and (b) at least one metal oxide from the group Al₂O₃, Y₂O₃, Sc₂O₃, CaO, SrO, BaO and (c) at least one mixed oxide made up of at least one of (i) an alkaline earth metal oxide, (ii) a rare earth metal oxide, (iii) Al₂O₃, (iv) Y₂O₃ and (v) Sc₂O₃, the additive material having a negative enthalpy of formation greater than 800 kJ/mol O₂, and a proportion of the additive material amounting to between 5 vol. % and 50 vol. %.

35. The electrode according to claim 34, wherein the proportion of the additive material amounts to between 10 vol. % and 30 vol. %.

36. The electrode according to claim 34, wherein an average particle diameter of the additive material is one of (a) between 0.5 μm and 20 μm and (b) between 1 μm and 7 μm.
